(19) United States
(12) Patent Application Publication
(10) Pub. No.: US 2010/0268689 A1
(43) Pub. Date: Oct. 21, 2010

(54) PROVIDING INFORMATION RELATING TO USAGE OF A SIMULATED SNAPSHOT

(76) Inventors: Matthew S. Gates, Houston, TX (US); Bradley G. Culter, Magnolia, TX (US); Donald C. Milos, Wynantskill, NY (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/424,076

(22) Filed: Apr. 15, 2009

(51) Int. Cl. G06F 12/16; G06F 17/30

(52) U.S. Cl. 707/649; 707/E17.014; 707/E17.005

(57) ABSTRACT

At least one simulated snapshot is created for a parent volume stored on a storage subsystem. A processor updates the at least one simulated snapshot in response to modification operations to the parent volume, wherein the at least one simulated snapshot stores metadata but not any prior version of data that is modified in response to the modification operations to the parent volume. The processor provides information relating to usage of the at least one simulated snapshot based on accessing the metadata of the at least one simulated snapshot.

### BACKGROUND

With advancements in storage technology, the amount of data that can be stored in storage subsystems, which include hard disk drives, disk array systems, and so forth, has increased dramatically. In a large enterprise (e.g., company, educational organization, government agency, etc.), there can be a relatively large number of storage subsystems. In addition to storing data that is used by applications and users, copies of the data stored in the storage subsystems can also be maintained. Copies of data in storage subsystems can be maintained for various purposes, including data backup, data mining (in which the data is analyzed to provide a better understanding of the data), and so forth.

A snapshot is one type of a data copy. A snapshot is a point-in-time representation of data. A snapshot contains blocks of data of a parent storage volume that have been changed due to one or more write operations (note that unchanged data in the parent storage volume is not copied to the snapshot). In response to writes that modify data in the parent storage volume, the original data is copied to the snapshot prior to writing to the parent storage volume.

Typically, snapshots are relatively space-efficient since snapshots store just differences from the original data stored in the parent storage volume. A benefit of using space-efficient snapshots is that users can create a relatively large number of snapshots without having to purchase a large amount of additional storage devices to hold the snapshots.

However, conventionally, having to decide how many storage devices to add to a system to support snapshots in a given environment typically involves guesswork on the part of personnel implementing a storage infrastructure. It is often difficult to predict how much information will actually be stored in the snapshots over the lifetime of such snapshots.

### BRIEF DESCRIPTION OF THE DRAWINGS

Some embodiments of the invention are described with respect to the following figures:

FIGS. 1 and 2 illustrate an exemplary arrangement including a parent volume, a snapshot volume, and a resource volume, that can be part of a storage subsystem incorporating simulated snapshot volumes according to some embodiments of the invention;

FIG. 3 is a schematic diagram of a system that includes a user terminal and a storage subsystem that includes a simulated snapshot volume according to an embodiment;

FIG. 4 is a schematic diagram of a parent volume and a simulated snapshot volume according to an embodiment, where the simulated snapshot volume includes metadata;

FIG. 5 is a schematic diagram of a system that includes a storage subsystem containing a simulated snapshot volume according to an embodiment;

FIG. 6 is a block diagram of components in an exemplary storage subsystem according to an embodiment;

FIG. 7 is a flow diagram of a process of tracking usage associated with a simulated snapshot volume, according to an embodiment; and

FIG. 8 is a flow diagram of a process of obtaining information relating to snapshot usage, according to an embodiment.

### DETAILED DESCRIPTION

In a storage subsystem according to some embodiments, simulated snapshots are used to track snapshot usage in response to modifications of data in a parent volume that is stored in the storage subsystem. A simulated snapshot contains metadata to indicate whether or not content of the parent volume has been modified in response to modification operations. However, the simulated snapshot does not store actual data that would normally be stored by a snapshot in response to modifications of data in the parent volume. Information relating to usage of the simulated snapshot can be derived based on accessing the metadata of the simulated snapshot. Using the information relating to usage of the simulated snapshot, an amount of storage resources to allocate for one or more actual snapshots of the parent volume can be determined.

By using simulated snapshots according to some embodiments, a relatively efficient technique is provided to accurately determine the amount of resources to allocate to storing snapshots. Conventionally, having to decide how many storage devices to add to a system to support snapshots in a given environment involves guesswork on the part of personnel implementing a storage infrastructure. It is often difficult to predict how much information will actually be stored in the snapshots over the lifetime of such snapshots. The amount of storage space consumed by a snapshot is dependent upon various factors, including: the rate of change of the parent volume, the length of time for which the snapshot is to exist, and details associated with the snapshot algorithm itself. Enterprises making purchasing decisions will not typically know about such details ahead of time. As a result, either too few or too much storage resources may be allocated for storing snapshots. Allocating too much storage resources for snapshots is wasteful and can lead to increased storage infrastructure costs. On the other hand, if too few storage resources are allocated, then that can result in reduced performance or even downtime if storage resources become unavailable.

By using simulated snapshots according to some embodiments, actual operations of a storage subsystem in a real environment (that may include access of a storage subsystem by user terminals, applications, and so forth) and how such actual operations affect data storage in snapshots can be monitored. The actual operations include write operations and other operations (e.g., delete operations) that modify the content of a parent volume, which typically trigger a copy-on-write operation to copy data from the parent volume to a snapshot. With a simulated snapshot, however, the metadata relating to such modification operations is updated, but actual data is not copied to the simulated snapshot, which allows the simulated snapshot to not consume a lot of storage space.

A “volume” refers to a logical unit of data that is contained in the storage subsystem. A “parent volume” refers to a logical unit of data to which input/output (I/O) operations, including reads, writes, deletes, and so forth, are typically performed. A “snapshot” refers to a logical unit of data that contains a previous version of data stored in the parent volume (prior to a write or delete operation, for example). The snapshot can be provided in a storage subsystem for various purposes, including data backup (to enable data recovery in case of faults, errors, or failures), data mining (to allow analysis of data to better understand the data), and/or for other purposes.

A storage subsystem that includes parent volumes and snapshots can be a subsystem contained in a single chassis, or alternatively, the storage subsystem can include distributed storage elements, such as storage elements of a storage area network.

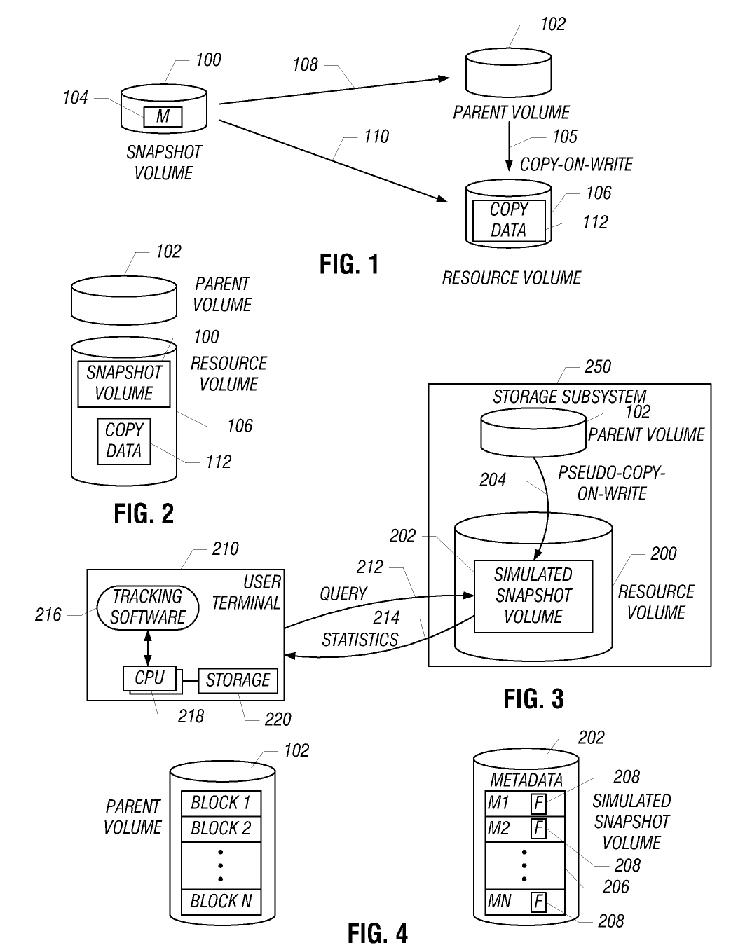

In one implementation, as shown in FIG. 1, a snapshot associated with a parent volume 102 can be considered to be the combination of a snapshot volume 100 and a resource volume 106. Note that the snapshot volume 100 is a virtual volume that is actually not allocated any physical storage resources. Instead, the resource volume 106 that is associated with the snapshot volume 100 is allocated physical storage resources for storing copy data 112 (copied in copy-on-write operations 105 from the parent volume 102 to the resource volume 106).

As further depicted in FIG. 1, the snapshot volume 100 is associated with metadata 104, which includes mapping information that maps blocks of data in the snapshot to corresponding blocks in the parent volume 102 and resource volume 106. A “block” of data refers to some collection of data, wherein the collection of data can have a predefined size or variable size. The mapping is represented by arrows 108 and 110, where the arrow 108 represents mapping of blocks of the snapshot to corresponding blocks of the parent volume 102. Such blocks of the parent volume 102 have not been modified by write or delete operations, and therefore, the snapshot does not contain any data associated with such unmodified blocks. The arrow 110 represents mapping of blocks of the snapshot to corresponding blocks of the resource volume 106—these blocks in the resource volume 106 contain a prior version of data contained in the corresponding block of the parent volume 102 prior to modification.

To a user or application, the snapshot volume 100 appears to be a fully functional volume that is a full copy of the parent volume 102. In reality, the data for the snapshot volume 100 is actually stored in different volumes: data that has been modified after the snapshot was taken resides on the resource volume 106, while data that has not been modified continues to reside on the parent volume 102. The metadata 104 associated with the snapshot volume 100 points (at 108) to blocks of the parent volume 102 that are unmodified since the snapshot was created, while the metadata 104 points (at 110) to corresponding blocks of the resource volume 106 for those blocks that have been modified in the parent volume 102.

FIG. 2 shows that the snapshot volume 100 (and the metadata 104 associated with the snapshot volume 100) is actually contained in the resource volume 106, along with the copy data 112. In an alternative implementation, instead of implementing a snapshot as a virtual snapshot volume 100 and a resource volume 106, the snapshot can be implemented as a snapshot volume that includes both metadata and actual copy data.

Initially, the snapshot depicted in FIG. 1 is empty (the resource volume 106 does not contain any copy data). However, in response to a modification operation to change a block of the parent volume 102, a copy-on-write operation (105) is performed, in which the block of data of the parent volume 102 that is to be modified is read and written to the resource volume 106. Also, metadata 104 associated with the snapshot volume 100 is updated to keep track of the block that has been modified. Any write data is then written to the parent volume 102.

The snapshot depicted in FIGS. 1 and 2 is an actual snapshot, since the resource volume 106 associated with the snapshot also stores copy data 112 (prior versions of modified data in the parent volume 102).

In contrast, FIG. 3 shows a simulated snapshot that is formed of a simulated snapshot volume 202 and a resource volume 200. The simulated snapshot volume 202 is stored in the resource volume 200. Note, however, the resource volume 200 does not store copy data that includes prior versions of modified data of the parent volume 102. The parent volume 102 and resource volume 200 are contained in a storage subsystem 250 that is coupled to a user terminal 210 (such as over a network or other type of communications link). The user terminal 210 can be a computer or other type of electronic device (e.g. personal digital assistant, etc.). The user terminal 210 can be the terminal associated with an administrator who is responsible for determining the amount of storage resources to allocate for storage of snapshots in the storage subsystem 250, for example.

In response to a write or other modification to the parent volume 102, a pseudo-copy-on-write (204) is performed to cause metadata in the simulated snapshot volume 202 to be updated. For example, if a particular block of the parent volume 102 is to be modified by a first write, then the pseudo-copy-on-write (204) causes the corresponding metadata in the simulated snapshot volume 202 to be updated to indicate that the simulated snapshot volume 202 is supposed to store a copy of the previous version of the particular block. The metadata can contain a flag or other indicator for each block of the parent volume, where the flag indicates that the simulated snapshot volume 202 is supposed to contain a copy of the previous version of the corresponding block of the parent volume. Stated differently, the flag indicates whether or not the corresponding block of the parent volume has been modified, such that the prior version of such block would normally be copied to a snapshot.

If there are N blocks (where N>1) in the parent volume 102, then there would be N corresponding pieces of metadata maintained in the simulated snapshot. As shown in FIG. 4, there are N pieces of metadata (M1, M2 . . . , MN) in the simulated snapshot volume 202 for corresponding blocks 1 to N in the parent volume 102. Each piece of metadata Mi (i=1 to N) contains a corresponding flag 208 that is set to a first state if the piece of metadata corresponds to a block in the parent volume 102 that has not been modified. However, the flag 208 is set to a second state if the corresponding block in the parent volume 102 has been modified. In some embodiments, the flag 208 can be a 1-bit value that can have a logical “0” or “1” value. If a flag 208 of metadata Mi is set, then that indicates that block i in the parent volume 102 has been modified and the simulated snapshot volume 202 is supposed to store a copy of the prior version of block i.

To enable a determination of usage of the simulated snapshot, operations are performed in the storage subsystem 250 containing the parent volume 102 and simulated snapshot volume 202. These operations are operations that would normally occur in a real environment. Some of the operations cause modifications of the parent volume 102. After some predetermined amount of time or in response to another event, an administrator at a user terminal 210 can issue a query (212) to the simulated snapshot volume 202 to retrieve statistics relating to usage of the simulated snapshot volume 202. The statistics (214) that are retrieved from the simulated snapshot volume 202 can be in the form of a count of the number of flags 208 in the metadata 206 that have been set to the second state (which indicate that the corresponding blocks in the parent volume has been modified). In an alternative implementation, instead of returning the count, the actual states of corresponding flags can be retrieved and sent to the user terminal 210. The statistics (214) can be provided in the form of a user report or other type of summary to the user terminal for viewing by the administrator. The statistics (214) can be used to determine the amount of storage resources that are to be allocated to snapshot volumes for the parent volume 102.

The query (212) can be issued by tracking software 216 executable on one or more central processing units (CPUs) 218 in the user terminal 210. The CPU(s) 218 can be connected to a storage 220 of the user terminal 210. Statistics (214) that are received from the storage subsystem 250 can be stored in the storage 220 for use by the user of the user terminal 210. For example, the tracking software 216 can be used to provide a visualization of the statistics 214, which can be in the form of a graph, report, chart, and so forth. In this manner, snapshot usage can be tracked without actually having to perform actual copies-on-write.

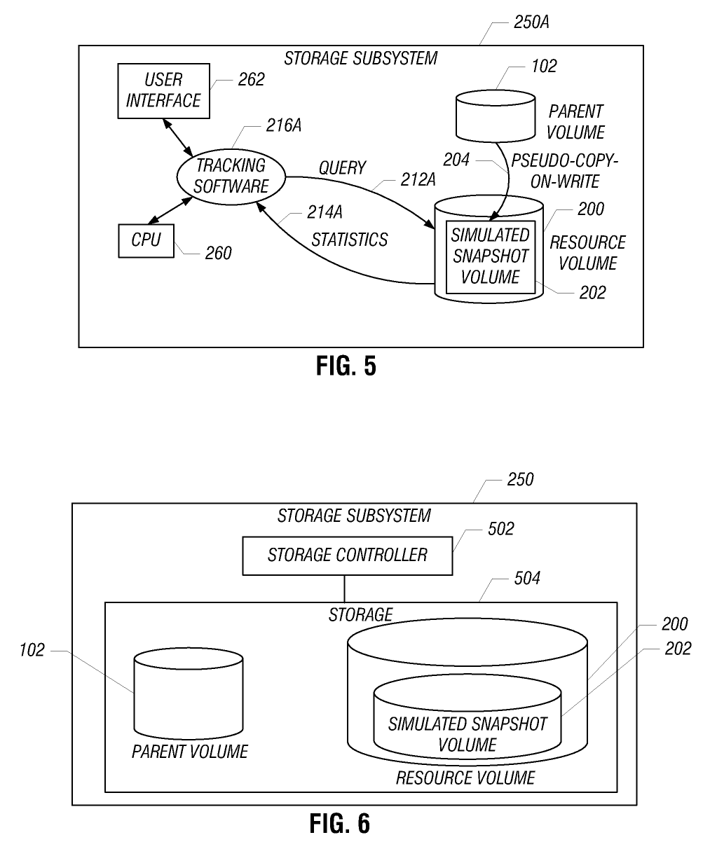

Although the tracking software 216 is shown in the user terminal 210 that is separate from the storage subsystem 250, it is noted that the tracking software 216 can alternatively be included in the storage subsystem. Such an alternative arrangement is shown in FIG. 5, which depicts a storage subsystem 250A having tracking software 216A that is executable on one or more CPUs 260. The storage subsystem 250A also includes the parent volume 102 and a simulated snapshot that includes the simulated snapshot volume 202 and the resource volume 200. A user interface 262 is provided to allow user interaction with the tracking software 216A. The tracking software 216A is able to issue a query 212A to the simulated snapshot to obtain snapshot statistics, and the statistics (214A) can be provided to the tracking software 216A in response to the query 212A

Although the example of FIGS. 3-5 show just one simulated snapshot for the parent volume 102, it is noted that multiple simulated snapshot volumes can be created for the parent volume 102. These multiple simulated snapshots can be simulated snapshots created at different points in time for the parent volume 102. In the scenario where there are multiple simulated snapshots maintained for a single parent volume, then statistics regarding usage of the multiple simulated snapshots are retrieved for determining the amount of storage resources to allocate to snapshots for the parent volume 102.

FIG. 6 shows a block diagram of the storage subsystem 250 according to an example that includes a storage controller 502 connected to storage media 504. In some embodiments, the storage controller 502 can be a storage controller that implements data redundancy according to a RAID (redundant array of inexpensive disks) algorithm. In a different implementation, the storage controller 502 can be another type of controller.

The storage media 504 can be implemented with one or more storage devices, such as disk-based storage devices, semiconductor storage devices, or other types of storage devices. The parent volume 102 and resource volume 200 that contains the simulated snapshot volume 202, as discussed above, are stored on the storage media 504.

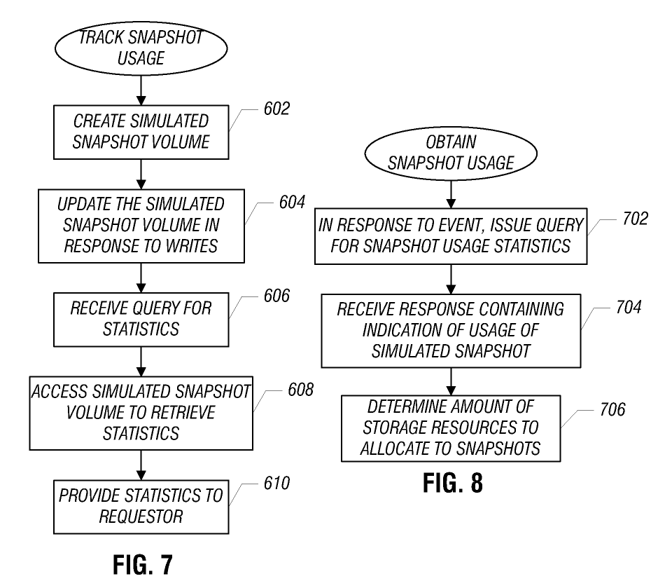

FIG. 7 is a flow diagram of the process of tracking snapshot usage using one or more simulated snapshot volumes. The process causes at least one simulated snapshot volume to be created (at 602). Creation of the simulated snapshot can be in response to a command received by the storage controller 502 (such as from the tracking software 216 or 216A of FIG. 3 or 5). The storage controller 502 (FIG. 6) can respond to such command to create the simulated snapshot volume. Note that the commands to create multiple simulated snapshot volumes can be submitted at different times such that the multiple simulated snapshot volumes are created at different points in time.

In response to I/O operations that modify data in the parent volume 102 (FIG. 6), the storage controller 502 updates (at 604) the simulated snapshot volume. At a later time, the storage controller 502 can receive (at 606) a query for statistics associated with the simulated snapshot volume 202. In response to such query, the storage controller 502 accesses (at 608) the simulated snapshot volume to retrieve statistics. As noted above, retrieving statistics can involve generating a count of the number of flags 208 (FIG. 4) set to the second state. Alternatively, the statistics that are retrieved can be the states of each of the flags 208.

The statistics are then provided (at 610) to the requester, such as the user terminal 210 shown in FIG. 3 or the user interface 262 in FIG. 5.

FIG. 8 is a flow diagram of a process for obtaining information relating to snapshot usage, according to an embodiment. In some embodiments, the process of FIG. 8 can be performed by the tracking software 216 or 216A of FIG. 3 or 5.

In response to an event (e.g., expiration of a predefined time interval, user request, or other event), the tracking software 216 or 216A issues (at 702) a query for usage statistics associated with the simulated snapshot. In response to the query, the tracking software receives (at 704) an indication of the usage of the simulated snapshot. The tracking software can use the indication of usage of the simulated snapshot to determine (at 706) the amount of storage resources to allocate for snapshots for the parent volume 102. Alternatively, instead of performing task 706 with the tracking software, task 706 can be performed by a human.

As yet another alternative, instead of a human interacting with the system to use simulated snapshots to plan provisioning of the storage resources, an intelligent system (including software and hardware) can be provided external of the storage subsystem. A user can then submit a request to ask for snapshots to be taken. In response, the automated system can perform the following automatically: (1) create the simulated snapshot(s) for a specified parent volume; (2) collect statistics by the simulated snapshot(s) over a specified period of time (which can be a default time, or a calculated time based on monitoring statistics periodically); (3) after the specified period of time, stop the simulated snapshot(s); (4) calculate the storage resources to be provisioned based on the original request in step (1) plus the now gathered real-time data; and (5) automatically begin actual snapshot collection.

Instructions of software described above (including the tracking software 216 of FIG. 3 and any software executable on the storage controller 502 of FIG. 5) are loaded for execution on a processor (such as one or more CPUs 218 in FIG. 3 or a processor associated with the storage controller 502 of FIG. 5). The processor includes microprocessors, microcontrollers, processor modules or subsystems (including one or more microprocessors or microcontrollers), or other control or computing devices. As used here, a “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
creating at least one simulated snapshot for a parent volume stored on a storage subsystem;
updating, by a processor, the at least one simulated snapshot in response to modification operations to the parent volume, wherein the at least one simulated snapshot stores metadata but not any prior version of data that is modified in response to the modification operations to the parent volume; and
providing, by the processor, information relating to usage of the at least one simulated snapshot based on accessing the metadata of the at least one simulated snapshot.

2. The method of claim 1, further comprising determining an amount of storage resources to allocate for one or more actual snapshots of the parent volume based on the information relating to usage of the at least one simulated snapshot.

3. The method of claim 2, further comprising an automated system receiving a request to take a snapshot for the parent volume, wherein the creating, updating, providing, and determining are performed automatically by the automated system in response to the received request.

4. The method of claim 1, wherein providing the information relating to usage of the at least one simulated snapshot comprises providing a count of a number of blocks of data of the parent volume that have been modified.

5. The method of claim 4, further comprising computing the count by performing an aggregation based on indicators contained in the metadata of the at least one simulated snapshot that indicate that corresponding blocks of data of the parent volume have been modified.

6. The method of claim 1, wherein providing the information relating to usage of the at least one simulated snapshot comprises sending indicators contained in the metadata, wherein the indicators are for indicating whether or not corresponding blocks of data of the parent volume have been modified.

7. The method of claim 6, further comprising aggregating the indicators to determine storage usage by the at least one simulated snapshot.

8. The method of claim 1, wherein providing the information relating to the usage of the at least one simulated snapshot comprises sending the information relating to the usage of the at least one simulated snapshot to a remotely located requester.

9. The method of claim 1, wherein creating the at least one simulated snapshot comprises creating the at least one simulated snapshot that includes a storage resource to store the metadata, wherein the storage resource is not allocated to store data of the parent volume.

10. The method of claim 1, further comprising:
in response to a particular modification operation that modifies a block of the parent volume, performing a pseudo-copy-on-write operation to the at least one simulated snapshot that causes the at least one simulated snapshot to update the simulated snapshot's metadata to indicate that the block of the parent volume has been modified.

11. A storage subsystem comprising:
a storage controller; and
storage media to store a parent volume and at least one simulated snapshot, wherein the at least one simulated snapshot is to store metadata to indicate whether or not data in the parent volume has been modified,
wherein the storage controller is configured to respond to an operation to modify content of the parent volume by updating the metadata of the at least one simulated snapshot without causing any data of the parent volume to be written to the at least one simulated snapshot.

12. The storage subsystem of claim 11, wherein the parent volume has plural blocks, and wherein the metadata of the at least one simulated snapshot contains corresponding plural pieces of metadata, wherein each of the pieces of metadata includes an indicator of whether or not a corresponding block in the parent volume has been modified.

13. The storage subsystem of claim 12, wherein the storage controller is configured to retrieve the indicators in response to a query and to produce an indication of usage of the at least one simulated snapshot.

14. The storage subsystem of claim 13, wherein the indication of usage of the at least one simulated snapshot comprises a sum of a number of indicators that indicate that the corresponding blocks of the parent volume have been modified.

15. The storage subsystem of claim 13, wherein the query is received from a remote terminal, and wherein the storage controller is configured to send the indication to the remote terminal.

16. An article comprising at least one computer-readable storage medium containing instructions that upon execution cause a processor to:
send a query to a storage subsystem that stores a parent volume and at least one simulated snapshot, wherein the at least one simulated snapshot is to store metadata associated with modified data of the parent volume without storing any data of the parent volume; and
receive, in response to the query, an indication of usage of the simulated snapshot.

17. The article of claim 16, wherein receiving the indication of usage of the simulated snapshot comprises receiving a count derived from the metadata of the at least one simulated snapshot, wherein the count represents a number of blocks of the parent volume that have been modified.

18. The article of claim 16, wherein receiving the indication of usage of the simulated snapshot comprises receiving indicators contained in the metadata of the at least one simulated snapshot, wherein the indicators are for indicating whether or not corresponding blocks of the parent volume have been modified.

19. The article of claim 16, wherein the instructions upon execution cause the processor to further:
determine, based on the indication of usage, an amount of storage resources to allocate to one or more actual snapshots for the parent volume.
